(19) United States
(12) Patent Application Publication
(10) Pub. No.: US 2025/0370931 A1
(43) Pub. Date: Dec. 4, 2025

(54) REFERENCE COUNTING SYSTEM FOR MULTI-PURPOSE AND NON-UNIFORM MEMORY ARCHTECTURES

(71) Applicant: Dell Products L.P., Round Rock, TX (US)

(72) Inventors: Lachlan McIlroy, Newport (AU); Robert Shelton, Geelong (AU); Anton Rang, Houlton, WI (US)

(21) Appl. No.: 18/675,371

(22) Filed: May 28, 2024

(51) Int. Cl. G06F 12/0815

(52) U.S. Cl. CPC G06F 12/0815

(57) ABSTRACT

Per-CPU reference counting leveraging per-CPU operations is presented herein. An example method comprises receiving a read request for access to shared data from a thread executing on one processor of a multi-processor core, determining that the shared data is unavailable in a first cache memory, transmitting the read request to storage server equipment, polling a second cache memory to determine that the shared data is unavailable in the second cache memory, based on the unavailability of shared data in the first cache memory and second cache memory, sending the shared data to the first cache memory, providing access to the shared data, incrementing a counter value, and based on the shared data having been modified, writing the modified shared data to the first cache memory for future access to the modified shared data by the thread.

### BACKGROUND

Reference counting is a method by which a count value is kept that tracks the number of references held for a defined groups of resources (e.g., processing resource, networking resource, memory resource, and the like). Reference counting allows resources to be shared and then safely reclaimed when a reference count value falls to zero. In multi-threaded systems, mutually exclusive locks can ensure that increment, decrement, and reclaim operations appear atomic (e.g., the operations execute without perceived interruption). However, locking overhead can become unacceptable as the number of simultaneous threads operating based on a reference count value increases.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a system for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 2 depicts a block diagram of a system for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 3 illustrates another block diagram of a system for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 4 provides additional illustration of a system for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 5 illustrates a flow chart, method, or time sequence chart for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 6 depicts a further flow chart, method, or time sequence chart for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 7 depicts a further flow chart, method, or time sequence chart for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 8 illustrates another flow chart, method, or time sequence chart for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 9 depict a further flow chart, method, or time sequence chart for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 10 provides another flow chart, method, or time sequence chart for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 11 provides an additional flow chart, method, or time sequence chart for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various non-limiting example embodiments.

FIG. 12 illustrates an elastic cloud storage (ECS) system, in accordance with various non-limiting example embodiments.

FIG. 13 illustrates a block diagram representing an illustrative non-limiting computing system or operating environment in which one or more aspects of various non-limiting embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As observed above, reference counting is a method by which a count value is kept that tracks the number of references held for a defined groups of resources (e.g., processing resource, networking resource, memory resource, and the like). Reference counting allows resources to be shared and then safely reclaimed when a reference count value falls to zero. In multi-threaded systems, mutually exclusive locks can ensure that increment, decrement, and reclaim operations appear atomic. However, the use of locking mechanisms can substantially increase locking overhead, becoming unacceptable as the number of simultaneous threads operating commensurate with a reference count value increases, thereby impacting and/or increasing processing times associated with the completion of software in execution, severely increasing the probability of multiple processors being in waiting/bound states, and the like. Being in interminable wait/bound states can have many knock on consequences, particularly where the software in execution relates to highly time critical processes, such as banking operations, and/or processes that are extremely computer processor intensive, such as the execution of production computer fluid dynamics software code that in industrial applications can be both time critical and extremely multithreaded and multi-processor intensive.

One solution to overcome these issues can be to replace the use of locking mechanisms with atomic increment and atomic decrement operations. Illustrative locking mechanisms currently in use can comprise: mutual exclusion (mutex) synchronization mechanisms—at any point in time, allow only one thread of multiple processing threads to access shared resources; semaphore synchronization mechanisms—control access to shared resources using counters and queues of waiting threads; read/write locks—allow multiple threads to concurrently read a shared resource, but allow only one thread of the multiple threads to write to the resource at any point in time; spinlocks—locking mechanisms where a thread of multiple threads repeatedly “spins” in a loop, continuously checking to determine whether the lock is available until the resource at issue eventually becomes available, . . . .

While use of the foregoing locking mechanisms can alleviate and/or mitigate issues concerning locking overhead, the above noted locking mechanisms typically have been found to be inadequate in supporting non-uniform uniform memory architectures (NUMA) where the costs associated with coordinating memory access from multiple memory domains to a single reference count value can be a substantial bottleneck. These locking overhead and associated bottlenecks can be avoided and overcome by replacing a single reference counter with a per-processor (e.g., per-CPU) reference counter, where the sum of the per-CPU count values is determinative of the number of references associated with defined groups of sharable resources. Nevertheless, while the use of atomic increment operations and atomic decrement operations can improve increment and decrement efficiency, reclaiming released resources based on the use of atomic increment operations and atomic decrement operations can become more difficult because: (i) additional and more complicated synchronization primitives can be required to take point-in-time snapshots of all per-CPU count values; (ii) repeated polling to obtain per-CPU count values can be needed to determine when a total value reaches zero; and (iii) additional execution threads can be required if the resource reclamation cannot be incorporated into the decrement operation.

The disclosed and described claimed subject matter presents systems and methods for per-CPU reference counting that leverages per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios. Example complicated synchronization primitives can include: synchronization primitives that allow threads of a multiplicity of threads in execution to wait for defined conditions to become true before proceeding (e.g., conditional variables); read-copy-update synchronization mechanisms, mechanisms typically used where read operations to shared resources exceed write operations to the shared resources; transactional memory synchronization mechanisms that allow groups of resource accesses to be executed atomically as a single transaction; barrier synchronization primitives that allow threads of groups of multiple threads to synchronize execution at defined points in software in execution, thereby ensuring that all threads comprising the groups of threads reach a defined designated barrier before proceeding; transactional locking mechanisms that can combine elements related to traditional locking with transactional memory techniques to provide flexible and efficient synchronization mechanisms, etc.

Interrupt handling or interrupt service routines typically are routines or functions that can be invoked in response to defined interrupt signals being generated by hardware and/or software in execution; signals a processor that immediate attention is required for handling specific events or conditions.

Further, pre-emption provides the ability of a multitasking operating system to interrupt the execution of a currently executing task or process in order to allocate processor time to another task that has a higher priority or is ready to run. Preemption allows the operating system to manage CPU resources efficiently, ensuring that critical tasks are executed in a timely manner and that the system remains responsive to user interactions.

Additionally, and/or alternatively, inter-process interrupts, also known as inter-process communication interrupts or cross-process interrupts, relate to mechanisms by which a first process can asynchronously signal or notify a second process of an occurrence of an event or condition. In contrast to traditional interrupts, which are typically used for intercommunication between various hardware equipment and processors, inter-process interrupts facilitate communication between software in execution running as separate processes in an operating system.

Concerning atomic operations these can be operations that typically are guaranteed to be executed as a single, indivisible unit, without interruption from other processes or threads. In a multi-threaded or concurrent environment, atomic operations ensure that shared data is accessed and modified safely and consistently, without the risk of data corruption and/or race conditions (e.g., when the behavior of software in execution is dependent on a relative timing or interleaving of multiple concurrent threads or processes—where two or more threads of in multi-threaded or concurrent software in execution access shared resources or variables concurrently, and the final outcome is generally dependent on the order in which the threads execute).

The disclosure set forth herein also details a finalize operation that transitions increments and decrements from operating on a per-CPU counters to operating using a single atomic counter. As a result, the decrement operation, as disclosed herein, can detect when a reference count drops to zero without the need for additional polling and/or execution threads. It has been observed without limitation or loss of generality that the described systems and/or methods are generally best suited to applications where resource creation and/or reclamation are rare but increment and decrement operations are nonetheless frequent. It has further been observed that the disclosed systems and/or methods during testing and evaluation has been applied to file system equipment resources, wherein testing indicates improvements at or exceeding six percent and approaching more than eight percent on standardized performance evaluations when compared to prior single reference count methods.

The disclosed systems and methods, in accordance with various embodiments, provide a system, apparatus, or device comprising: at least one processor; and at least one memory that stores executable instructions that, when executed by the processor, facilitate performance of operations. The operations can comprise: receiving, from a thread of a group of threads, a read request for access to requested data, determining, based on the read request, that the requested data is unavailable in a first cache memory, based on the requested data being determined to be unavailable in the first cache memory, sending the read request for access to the requested data to storage server equipment for fulfillment of the read request, performing, by the storage server equipment, a snoop operation on a second cache memory, and transferring the requested data, from the storage server equipment, to the first cache memory, providing access, by the thread of the group of threads, to the requested data stored in the first cache memory, incrementing, by a processor of the at least one processor, a counter value stored in a counter variable maintained by the processor, and in response to the thread of the group of threads having modified the requested data to create modified requested data, writing the modified requested data to the first cache memory for future access to the modified requested data by the thread of the group of threads.

In some embodiments the thread of the group of threads can be a first thread of a first group of threads, the read request can be a first read request, the processor of the at least one processor can be a first processor of a first group of the at least one processor, the snoop operation can be a first snoop operation, the counter value can be a first counter value, the counter variable can be a first counter variable, the modified requested data can be first modified requested data, and the first thread of the first group of threads can be in execution on the first processor of the first group of the at least one processor, and the operations can further comprise: at a time in near contemporaneity with the receiving, from the first thread, the first read request for access to the requested data, receiving, from a second thread of a second group of threads in execution on a second processor of a second group of the at least one processor, a second read request for access to the requested data, determining, based on the second read request, that the requested data is unavailable in the second cache memory, based on the requested data being unavailable in the second cache memory, sending the second read request for access to the requested data to the storage server equipment for fulfillment of the second read request, causing the storage server equipment to perform a second snoop operation on the first cache memory, and transfer the requested data, from the storage server equipment, to the second cache memory, providing access, by the second thread of the second group of threads, to the requested data stored in the second cache memory, and in response to the second thread of the second group of threads having modified the requested data to create second modified requested data, writing the second modified requested data to the second cache memory for future access to the second modified requested data by the second thread of the second group of threads.

Additional operations can comprise incrementing, by the second processor, a second counter value stored in a second counter variable maintained by the second processor, wherein the first counter variable can be persisted to the first cache memory and the second counter variable can be persisted to the second cache memory. In some embodiments, the first cache memory services the first processor, and the second cache memory services the second processor, and the requested data can represent a resource that can be shared between the first group of the at least one processors and the second group of the at least one processors. Moreover, additional operations can comprise, in response to determining that the first counter value of the first counter variable stored in the first cache memory is greater than zero, operating the first processor in a per-CPU state, wherein subsequent first read requests can be serviced by the first cache memory, and wherein, in response to each of the subsequent read requests, a scheduler process operational on the first processor can be halted, an inter-processor interrupt process operational on the first processor can be halted, and the first counter value of the first counter variable can be incremented.

Other operations can comprise in response to determining that the first counter value of the first counter variable stored in the first cache memory is zero, executing the first processor operates in an atomic state, and in response to determining that the first counter value of the first counter variable stored in the first cache memory is zero, placing in hiatus a scheduler process operational on the first processor, placing in hiatus an inter-processor interrupt process operational on the first processor, and initiating a resource reclamation process that clears the first cache memory.

In accordance with further embodiments, the subject disclosure describes a method, comprising a sequence of acts that can include: receiving, by a processor of a multi-processor core, a read request for access to shared data from a thread of a group of threads in execution on the processor, based on the read request, determining, by the processor, that the shared data is unavailable in a first cache memory, facilitating, by the processor, transmitting the read request to storage server equipment, wherein the storage server equipment, in response to receiving the read request, is to poll a second cache memory to determine that the shared data is unavailable in the second cache memory, and based on the shared data being determined to be unavailable in the second cache memory, the storage server equipment is to send the shared data to the first cache memory, enabling, by the processor, access to the shared data to the thread of the group of threads, incrementing, by the processor, a counter value stored in a counter variable controlled by the processor; and based on the thread having modified the shared data to generate modified shared data, writing, by the processor, the modified shared data to the first cache memory for future access to the modified shared data by the thread.

Concerning the foregoing, the counter variable can be stored in the first cache memory and the incrementing of the counter value stored in the counter variable results in generation of an incremented counter value. Further, in some embodiments, the thread of the group of threads can be a first thread of a first group of threads, the processor can be a first processor of the multi-processor core, and the read request for access to the shared data can be a first read request for access to the shared data, and wherein a second thread of a second group of threads in execution on a second processor of the multi-processor core receives a second read request for access to the shared data. Additionally, and/or alternatively, the thread of the group of threads can be a first thread of a first group of threads, the processor can be a first processor of the multi-processor core, and the read request for access to the shared data can be a first read request for access to the shared data, the first processor controls access, by the first thread, to the first cache memory, and a second processor of the multi-processor core controls access, by a second thread of a second group of threads in execution on the second processor, to the second cache memory. In certain embodiments, the processor can be a first processor of the multi-processor core, and the shared data represents a resource that can be shared by the first processor and a second processor of the multi-processor core.

Further acts can comprise, in response to determining that the counter value associated with the counter variable stored in the first cache memory is zero, initiating a resource reclamation process that transfers the modified shared resource data stored in the first cache memory to the storage server equipment, wherein the read request can be a first read request, and the incrementing of the counter value comprises incrementing the counter value in response to the thread initiating a second read request for access to the modified shared data. Additional acts can comprise prior to the incrementing of the counter value stored in the counter variable, halting, by the processor, a scheduler process and an inter-processor interrupt process, and, in response to determining the incrementing of the counter value has completed, restarting the scheduler process and the inter-processor interrupt process.

In accordance with still further embodiments, the subject disclosure describes a machine-readable storage medium, a computer readable storage device, or non-transitory machine-readable media comprising instructions that, in response to execution, cause a computing system comprising at least one processor to perform operations. The operations can comprise: receiving a read request for access to shared data from a thread of a group of threads in execution on the at least one processor, based on the read request, determining that the shared data is unavailable in a first cache memory, in response to determining that the shared data is unavailable, transmitting the read request to storage server equipment, wherein the storage server equipment, in response to receiving the read request is to search a second cache memory to determine that the shared data is unavailable in the second cache memory, and based on the shared data being unavailable in both the first cache memory and the second cache memory, the storage server equipment sends the shared data to the first cache memory, providing access to the shared data to the thread of the group of threads, incrementing a counter value stored in a counter variable controlled by the at least one processor, and based on the thread having modified the shared data resulting in modified shared data, storing the modified shared data to the first cache memory for future access, by the thread, to the modified shared data. Additional operations can further comprise, prior to performing the incrementing of the counter value stored in the counter variable, halting a scheduler process associated with the processor, halting an inter-processor interrupt process associated with the processor, and, in response to determining that the incrementing of the counter value has completed, restarting the scheduler process and the inter-processor interrupt process.

As a high level overview, the disclosed systems and methods relate to per-CPU reference counting that leverages per-CPU operations in order to avoid using more complicated synchronization primitives typically used in concurrent programming to coordinate the execution of multiple threads or processes and manage shared computing resources in complex scenarios. The described per-CPU counting functionality can operate in two states, a per-CPU state and an atomic state. In the per-CPU state, reference counters can be incremented and conversely can be decremented using per-CPU counters. More succinctly, resource reclamation, while in a per-CPU state, is not performed. The processes that facilitate and effectuate resource reclamation, while in a per-CPU state, are not executed in order to free up resources no longer in use by software in execution.

In the context of computer systems, resource reclamation typically can involve reclaiming, for instance, memory resources, file handles, network connections, and/or other system resources that at an earlier time point were allocated to a thread of multiple executing threads but now the allocated resource(s) are no longer required by the thread of the multiple executing threads. Incrementing and decrementing per-CPU counters without performing resource reclamation allows the reference count to take full advantage of NUMA, avoiding cache coherence bottlenecks associated with multiple processors operating on a single atomic counter.

In the context of cache coherence and cache coherence bottlenecks, cache coherence relates to the consistency of data stored in different caches, ensuring that all processors in a multiprocessor system have a consistent view of shared data; cache coherence bottlenecks relate to situations in multiprocessor systems where the performance of the system is limited by the overhead and delays associated with maintaining cache coherence among multiple processor caches.

In the atomic state, a single counter can be used for all processors and the resources will be reclaimed when the counter drops to zero. The atomic state is typically a short-lived state prior to resource reclamation.

To accomplish transitioning between per-CPU states and atomic states a process can be provided that transitions the states from per-CPU (where each processor can have its own counters) to atomic (where a single counter can be used by all processors). The process coordinates transitions using inter-process interrupts (IPIs), control of per-CPU interrupt handlers, and control of per-CPU scheduler pre-emption.

Inter-process interrupts are mechanisms by which a first executing process can in some embodiments synchronously signal or notify a second executing process of an event or condition. Inter-process interrupts facilitate communication between separate processes running concurrently in an operating system.

Per-CPU interrupt handlers are specialized types of interrupt handlers that can be associated with a specific CPU or processor core in a multi-processor system. In such systems, each CPU can have its own interrupt handling routines, allowing for concurrent processing of interrupts across multiple processor cores. A per-CPU scheduler with preemption capability can be a scheduling mechanism used in multiprocessor systems where each CPU or processor core has its own scheduler that manages the execution of tasks on that CPU. Additionally, the scheduler generally has the ability to preempt currently running tasks to allow higher-priority tasks to be executed.

In accomplishing the transitions between per-CPU states and atomic states there is no necessity for repeated polling of per-CPU counters which in turn enables the decrement operation to detect when resource reclamation is possible.

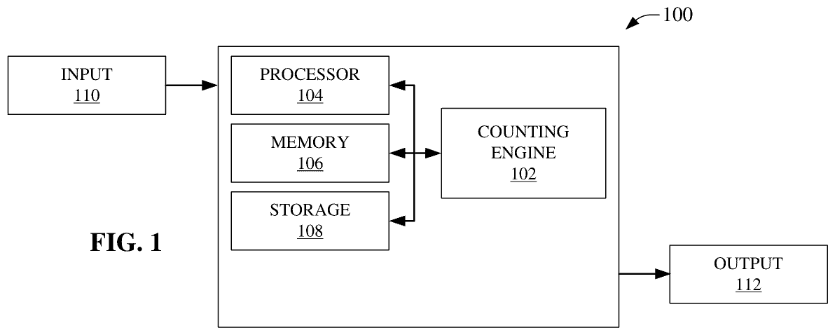

Now in reference to the Figures. FIG. 1 depicts a system 100 for per-CPU reference counting leveraging per-CPU operations, such as interrupt handing, pre-emption, inter-process interrupts, and the like to avoid the use of more complicated synchronization primitives used in concurrent programming to coordinate the execution of multiple threads or processes and manage shared resources in complex scenarios, in accordance with various example embodiments. System 100, for purposes of illustration, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing equipment, machines, and/or database equipment, laptop computers, notebook computers, desktop computers, cell phones, smart phones, consumer appliances and/or instrumentation, industrial devices and/or components, hand-held devices, personal digital assistants, multimedia Internet enabled phones, Internet of Things (IoT) equipment, multimedia players, and the like.

System 100 can comprise counting engine 102 that can be in operative communication with processor 104, memory 106, and storage 108. Counting engine 102 can be in communication with processor 104 for facilitating operation of computer-executable instructions or machine-executable instructions and/or components by counting engine 102; memory 106 for storing data and/or computer-executable instructions and/or machine-executable instructions and/or components; and storage 108 for providing longer term storage of data and/or machine-readable instructions and/or computer-readable instructions. Additionally, system 100 can also receive input 110 for use, manipulation, and/or transformation by counting engine 102 to produce one or more useful, concrete, and tangible result, and/or transform one or more articles to different states or things. Further, system 100 can also generate and output the useful, concrete, and tangible result and/or the transformed one or more articles as output 112.

System 100 in conjunction with counting engine 102 can operate in two states: PERCPU and ATOMIC, wherein in the PERCPU state, reference counts can be incremented and decremented using per-CPU counters and the shared or sharable resource (such memory resources, network resources, and the like) are never reclaimed while in the PERCPU state. This can allow the reference count to take full advantage of NUMA, thereby avoiding cache coherence bottlenecks associated with multiple processes in execution on one more processors and relying on a single atomic counter. In the ATOMIC state, a single counter can be used for all CPUs and the resource generally can be reclaimed when the single counter drops to zero. Under this conception, being in the ATOMIC state will typically be the short-lived state prior to resource reclamation.

In accomplishing the foregoing, counting engine 102 can use a process that transitions the state from PERCPU (e.g., each CPU in a processor core comprising a group of processors and/or a first CPU in a first processor core comprising a first group of processors and a second processor in a second disparate processor core comprising a distinct second group of processors) to an ATOMIC state (e.g., a single counter used by all CPUs—each CPU in the processor core comprising the group of processors and/or the first CPU in the first processor core comprising the first group of processors and the second processor in the second disparate processor core comprising the distinct second group of processors. Counting engine 102: coordinates the transitions from the PERCPU state to the ATOMIC state through use of inter-processor interrupts (IPIs)—mechanisms used in multiprocessor systems to facilitate communication and coordination between different processor cores or CPUs; inter-processor interrupts provide a means for a first processor to send a signal or interrupt to a second CPU, triggering a response or action on the recipient second CPU; controls a per-CPU interrupt handler—each processor of a CPU core can operate using its own dedicated interrupt handler, and counting engine 102 controls the dedicated interrupt handler associated with the processor; and controls per-CPU scheduler pre-emption.

A pre-emption scheduler is a process in execution on each processor comprising the CPU core and is generally used by the operating systems in execution on the processor to manage the execution of multiple tasks or processes; preemptive scheduling allows the underlying operating system to interrupt currently executing tasks and switch to other tasks with higher priorities when necessary. Pre-emption ensures that time-critical or high-priority tasks are executed promptly, even if lower-priority tasks are currently in execution. Use of the described counting engine 102 avoids the necessity to repeatedly poll per-CPU counters (e.g., counters tied to each processor comprising the CPU core) which in turn enables the described decrement process to detect when resource reclamation is possible.

Counting engine 102 can use of an object with three primary fields: (1) the current state; (2) a single counter for use in the ATOMIC state; and (3) an array of counters each associated with a single processing unit of a CPU core for use in the PERCPU state. The most significant bit (MSB) of the atomic count can be set to protect the resource from reclamation when transitioning from the PERCPU state to the ATOMIC state. The initial state of the object is described below.

```
percpu_refcnt {
  int state = PERCPU;
  int atomic_count = MSB;
  int percpu_count[NUM_CPU] = { 0, 0, 0, ..., 0};
};
```

Note the above object is a simplified view of the object, in practice the per-CPU counters can be separated in order to avoid cache line thrashing—a performance issue that occurs in computer systems with hierarchical memory architectures, such as CPUs with multiple levels of cache memory; cache line thrashing occurs when cache lines are repeatedly loaded and evicted from the cache, resulting in poor cache utilization and decreased performance. Concerning cache lines, a cache line can be the fundamental unit of data storage in cache memories—small, high-speed memory located between a CPU and main memory (such as random-access memory (RAM) in a computer system. The purpose of cache memories is to temporarily store frequently accessed data and instructions, allowing the CPU to access these frequently accessed data and instructions more quickly than had they been retrieved directly from the slower main memory.

Counting engine 102 can perform increment operations, wherein a current state value (e.g., PERCPU or ATOMIC) is read, and based on the current state value a determination can be made as to whether a per-CPU count value should be incremented or whether an atomic counter value should be incremented. Counting engine 102 generally needs to perform the reading of the state value (e.g., identifying whether the current state value is a PERCPU state value or an ATOMIC state value) and incrementing the per-CPU count value without the current processing thread in execution on the processor of the group of processors that comprise the CPU core being interrupted by either the pre-emption scheduler or by instantiating an inter-processor interrupt. An example pseudo code that counting engine 102 can use to perform the increment operation is presented below:

```
increment(ref)
{
  int state;
  disable_interrupts_and_premption( );
  state = atomic_read(&ref->state);
  if (state == PERCPU)
    counter_add(&ref->percpu_count, 1);
  enable_interrupts_and_premption( );
  if (state == ATOMIC)
    atomic_add(&ref->atomic_count, 1);
}
```

Concerning decrementing operations that can be performed by counting engine 102, decrementing typically is the inverse operation to the incremental operations. Once again, counting engine 102 must perform the decrementing operation without the current processing thread in execution on the processor of the group of processors being interrupted by the pre-emption scheduler and/or by instantiating an inter-processor interrupt. When counting engine 102 performs decrementing operations, a reference count value in an ATOMIC state, memory associated with a resource generally can only be reclaimed when the atomic counter value drops to zero. In the following example pseudo code, the atomic_add( ) functionality returns the previous value. A value of one indicates the atomic count is now zero.

```
decrement(ref)
{
  int state;
  disable_interrupts_and_premption( );
  state = atomic_read(&ref->state);
  if (state == PERCPU)
    counter_add(&ref->percpu_count, −1);
  enable_interrupts_and_premption( );
  if (state == ATOMIC)
    if (atomic_add(&ref->atomic_count, −1) ==
  1)
      reclaim(ref); /* atomic_count == 0 */
}
```

Counting engine 102 can also execute a further process, known as a finalize routine (or finalize process), that transitions the reference count from the PERCPU state value to the ATOMIC state value. The finalize routine, below, is generally only invoked by an executing thread that holds a reference for the resource. The finalize routine nonetheless can be invoked by multiple threads in execution on other processors comprising the processor core (as well as groups of additional threads that can be in execution on additional processors comprising additional processing cores), but only one will successfully perform the atomic compare-and-set operation and change the state values from a PERCPU state value to an ATOMIC state value. Counting engine 102 can use, for example, a function smp_rendezvous( ) to call the finalize_one_cpu functionality on each CPU, passing a reference to the reference count being finalized and an integer counter to sum the total number of references held in all per-CPU counters. The MSB can then be subtracted from the final count so that when the atomic add is performed, the atomic count field will reflect the actual number of references held.

```
finalize(ref)
{
  if (atomic_compare_and_set(&ref->state, PERCPU,
  ATOMIC)) {
    int final_count = 0;
    smp_rendezvous(finalize_one_cpu, ref,
  &final_count);
    final_count −= MSB;
    atomic_add(&ref->atomic_count, final_count);
  }
}
```

Typically, an inter-process interrupt runs on each CPU, collecting the current value of the per-CPU count and providing memory barriers to ensure that the updated state (ATOMIC) will be observable on each CPU. Below is an illustrative pseudo code segment for the finalize_one_cpu function that can be executed on each CPU, passing a reference to the reference count being finalized and an integer counter value to sum the total number of references held in all per-CPU counters.

```
finalize_one_cpu(ref, final_count)
{
  int count = counter_read_one_cpu(&ref-
  >percpu_count);
  if (count != 0)
    atomic_add(final_count, count);
}
```

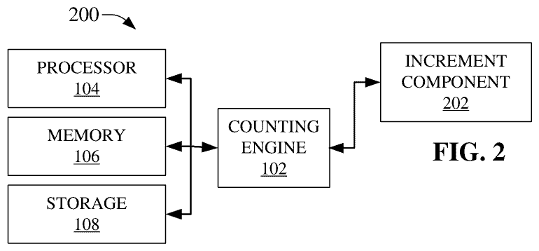

FIG. 2 provides additional illustration of system 100 (now depicted as system 200) for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various example embodiments. System 200 can comprise counting engine 102 that can operate in conjunction with increment component 202. Increment component 202 can effectuate the increment operations, wherein current state values can be read, and in response to identifying the value associated with current state a determination can be made in regard to whether a per-CPU count value should be incremented, or whether an atomic counter value should be incremented. Increment component 202, as noted earlier, must perform the reading of the state value as well as incrementing the per-CPU count value without the current processing thread in execution on the processor being interrupted by either the pre-emption scheduler associated with the processor or by causing an inter-processor interrupt. Increment component 202 can use the following code to perform the outlined increment functionality:

```
increment(ref)
{
  int state;
  disable_interrupts_and_premption( );
  state = atomic_read(&ref->state);
  if (state == PERCPU)
    counter_add(&ref->percpu_count, 1);
  enable_interrupts_and_premption( );
  if (state == ATOMIC)
    atomic_add(&ref->atomic_count, 1);
}
```

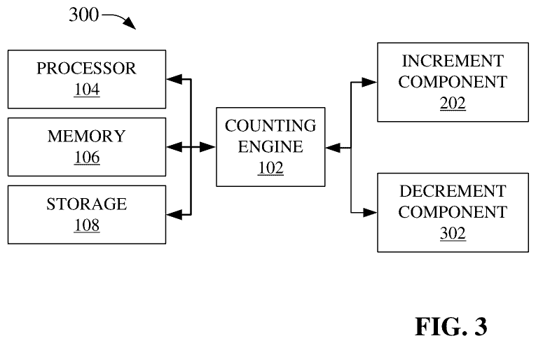

FIG. 3 provides additional illustration of system 200 (now depicted as system 300) for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various example embodiments. System 300 can comprise decrement component 302, that in collaboration with counting engine 102 and increment component 202, can be responsible for the decrementing functionality provided by system 300. Decrement component 302, like increment component 202, needs to perform decrementing without the current processing thread in execution being interrupted by the pre-emption scheduler and/or by instantiating an inter-processor interrupt, therefore interrupts and preemption can be disabled to ensure that the state is read and the per-CPU count decremented without interruption. When decrement component 302 performs decrementing operations a reference count value in an ATOMIC state, memory associated with a resource generally can only be reclaimed when the atomic counter value drops to zero. Once again it should be noted that the atomic_add( ) functionality returns the previous value, and a value of one indicates the atomic count is now zero. The following example code can effectuate the decrementing embodiments associated with the detailed decrementing component 302.

```
decrement(ref)
{
  int state;
  disable_interrupts_and_premption( );
  state = atomic_read(&ref->state);
  if (state == PERCPU)
    counter_add(&ref->percpu_count, −1);
  enable_interrupts_and_premption( );
  if (state == ATOMIC)
    if (atomic_add(&ref->atomic_count, −1) ==
  1)
      reclaim(ref); /* atomic_count == 0 */
  }
```

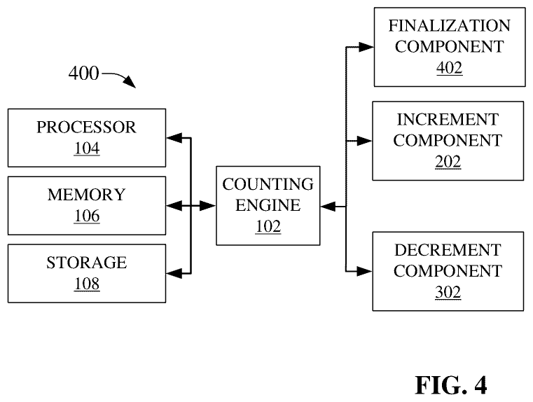

FIG. 4 depicts a yet further illustration of system 300 (now illustrated as system 400) for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various example embodiments. System 400, in addition to finalization component 402, can comprise counting engine 102, increment component 202, and decrement component 302. Finalization component 402, in concert with counting engine 102, increment component 202, and/or decrement component 302, via the execution of a finalize process set forth below, can transition reference counts from a first state value (e.g., PERCPU state value) to a second state value (e.g., ATOMIC state value). The process as presented below typically can be invoked by an executing thread of a collection of executing threads operational on at least one grouping of processors comprising a processor core (e.g., the executing thread of the collection of executing threads can be a first thread operating on a first processor associated with a first grouping of processors comprising a first processor core, whilst a second thread of the collection of threads can be associated with a functionality upon which the first thread is reliant and can be in execution on a second processor associated with a second grouping of processors comprising a second processor core. As has been noted earlier, when the finalize process is invoked by multiple threads in execution on first processors comprising a first processing core and/or distinct other second processors comprising second distinct other processing cores, only one processor at a time will be accorded the ability to successfully perform the atomic compare-and-set operation, and switch the state values from a PERCPU state value to an ATOMIC state value. Execution of the finalize process can employ functionalities of a smp_rendezvous( ) function to call a finalize_one_cpu functionality on each CPU, passing a reference to the reference count being finalized and an integer counter to sum the total number of references held in all per-CPU counters. The MSB can then be subtracted from the final count so that when the atomic add is performed the atomic count field will reflect the actual number of references held. Below is executable pseudo code associated with the disclosed finalize process:

```
finalize(ref)
{
  if (atomic_compare_and_set(&ref->state, PERCPU,
ATOMIC)) {
    int final_count = 0;
    smp_rendezvous(finalize_one_cpu, ref,
  &final_count);
    final_count −= MSB;
    atomic_add(&ref->atomic_count, final_count);
  }
}
```

Further, provided below is additional code that when placed in execution can perform the finalize_one_cpu functionality on each CPU.

```
finalize_one_cpu(ref, final_count)
{
  int count = counter_read_one_cpu(&ref-
>percpu_count);
  if (count != 0)
    atomic_add(final_count, count);
}
```

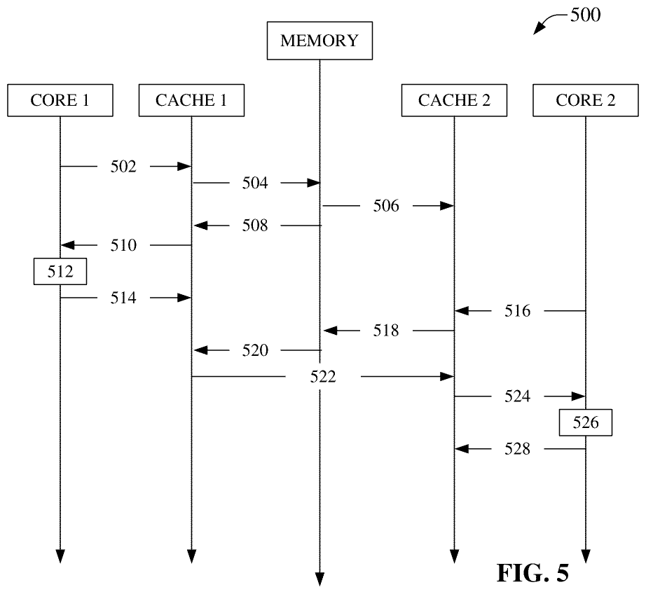

FIGS. 5-11 illustrate flowcharts, time sequences, and/or methodologies for performing operations corresponding to system 100, system 200, system 300 and system 400 in accordance with various example embodiments. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies and/or time sequences in accordance with the disclosed subject matter. In addition, those skilled in the art will understand and appreciate that the time sequences and/or methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 5 depicts a time-sequence diagram or flow diagram 500 for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various example embodiments. Time-sequence diagram or flow diagram 500 illustrates embodiments where there are atomic operations that are generally non-conflicting. The time-sequence can commence, at act 502, where a first thread of a first multiple of threads executing on a first processor of a first group of processors comprising a first processor core (or first core equipment) issues a first read request for data that can have been persisted to: (a) a first cache memory that is proximate to the first processor of the first group of processors associated with the first core equipment and/or (b) shared resources (e.g., data stored to remote database equipment/storage equipment). The first processor, at 502 in response to receiving the first read request for data and issued by the first thread can initiate a first read directive and first lock directive which can be sent to a first cache memory. In instances where the first cache memory is unable to satisfy the first read request (e.g., because the data does not exist in first cache memory), at act 504, the first read request can be directed to a shared resource (e.g., storage server equipment, database equipment, centralized data storage equipment, and the like) that is generally and commonly accessible to a plurality of processes executing on a diversity of core equipment. At act 506, a first snoop operation can be performed to determine the status of a second cache memory that can be proximate and servicing a second thread of a second multiple of threads executing on a second processor of a second group of processors associated, for example, with second core equipment. The first snoop operation, in addition to determining the status of the second cache memory can also determine whether or not the data requested by the first read request is resident in the second cache memory. In near contemporaneity with issuing the first snoop operation at act 506, and determining that the data necessary the first read request has not been persisted to the second cache memory, the first read request can be fulfilled and the requested data, at act 508, can be returned from the shared resource to the first cache memory, and, at act 510, subsequently returned to the first processor for access and/or use by the originating first thread operating on the first processor. On receiving indication that the requested data has been retrieved and has been persisted to the first cache, the first processor, at act 512, can update a first counter value that is associated with the first processor (e.g., all processors comprising processing cores can monitor, maintain and/or update their own collections of counters with appropriate counter values). In response to updating the first counter value, at act 514, a first unlock directive can be issued and a first write operation can be performed on the requested data resident in the first cache memory.

Shortly after, or in near time proximity with, the first processor having issued the first unlock directive and/or having performed, on behalf of the executing first thread, the first write operation on the retrieved data now resident in the first cache, at act 516, the second thread of the second multiple of threads executing on the second processor of the second group of processors comprising the second processor core (or second core equipment) can issue a second read request for the data (i.e., the data being requested by the first thread and/or the second thread can be the same, or a common, collection of data) that can have been stored to: (i) a second cache memory that is local to the second processor of the second group of processors associated with the second core equipment and/or (ii) shared resources that can be equidistant to both the first core equipment and the second core equipment. The second processor, at act 516, in response to receiving the second read request can initiate a second read directive and a second lock directive which is directed to the second cache memory. Where the second cache memory is unable to fulfill the second read request, at act 518, the second read request can be sent to the shared resource. At act 520, a second snoop operation can be performed to determine whether the first cache memory has the data to fulfill the second read request. At this juncture since the first cache memory has the data needed to fulfill the second read request the data can be sent from the first cache memory to the second cache memory at act 522. Once the data that fulfills the second read request is resident in the second cache memory, at act 524, the retrieved data can be used by the second thread that requested the data. At act 526, in response to receiving an indication that the data is resident in the second cache memory and is being used by the second thread, the second processor upon which the second thread is in execution, can update a second counter value. In response to the second processor updating the second counter value, the second processor, at act 528, can issue a second unlock directive perform second write operations to the data now resident in the second cache memory.

For the sake of brevity and ease of exposition, concerning a first thread of a first multiple of threads executing on a first processor of a first group of processors comprising a first processor core or first core equipment, further reference to this statement hereinafter will be referred to, where needed, as: a first thread; a first processor; and a first processor core. Similarly, with reference to a second thread of a second multiple of threads executing on a second processor of a second group of processors comprising a second processor core or second core equipment will hereinafter be referred to, where needed, as: a second thread; a second processor; and a second processor core.

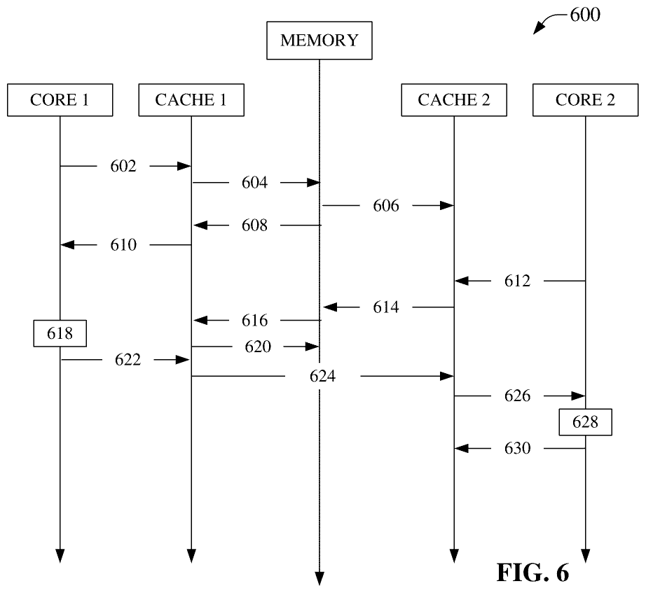

Now with reference to FIG. 6 that depicts a time-sequence diagram or flow diagram 600 for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various example embodiments. Time-sequence diagram or flow diagram 600 illustrates embodiments where there are atomic operations that are generally in conflict. In regard to time chart 600 it will be noted that acts 602 to 610 are substantially similar to those disclosed in the context of time chart 500 and acts 502 to 510, thus for the sake of brevity, and to avoid unnecessary repetition, further description related to acts 602 to 610 have been omitted. Accordingly, at act 612 of time chart 600, subsequent to having received indication that the requested data now resides in, and is accessible by the first read request invoking first thread executing on the first processor from the first cache memory at 610, a second thread in execution on a second processor of a second processor core can issue a second read request for the data, initiating a second read directive and/or a second lock directive that can be forwarded to a second cache memory. Upon determining that the requested data does not exist in the second cache memory, at act 614, the second read request can be directed to the shared resource (e.g., storage service equipment, networked (cloud) database equipment, and the like) for the second read request for data to be satisfied. Prior to the shared resource fulfilling the second read request, the shared resource, at act 616, can perform a second snoop operation that can poll the first cache memory to determine whether or not the first cache memory already has the data needed to satisfy the second read request. In this instance, since the data requested by the second thread is currently extant in the first cache memory, and because the requested data in the first cache memory remains under a first lock directive initiated by the first thread, a locked wait indication, at act 620, can be implemented (e.g., access to the data requested by the second read request is denied, thus fulfillment of the second read request can be placed in a temporary state of hiatus). Contemporaneously with the locked wait state being implemented at act 620, or shortly thereafter, the first processor associated with the first thread, at act 618, can update a first counter value (e.g., in the embodiments detailed herein, the first counter value is initialized, monitored, updated, and controlled solely by the first processor—as has been noted earlier, for purposes of the disclosed embodiments, each and every processor comprising a core multi-processor entity is substantially responsible for its own counter values). Once the first thread operating on the first process has complete using (e.g., reading, modifying, updating, and/or writing to the first cache memory) the first processor can issue first write directives and/or first unlock directive thereby relinquishing access to the shared resource, at act 622. In response to the release of the resource being relinquished by the first processor at act 622, the data requested by the second read request issued at act 612 can be satisfied by moving the data request by the second read request to the second memory cache, at act 624, at which point the second thread executing on the second processor can access and update the requested data at act 626. At act 628, the second processor can update its counters (e.g., a second counter solely controlled by the second processor) with a second counter value. Thereafter, once the second thread operating on the second processor has complete and fulfilled its tasks associated with the sought after and requested data the second thread can direct the second processor to perform a write operation and release the lock that can have been imposed on the shared resource at act 630.

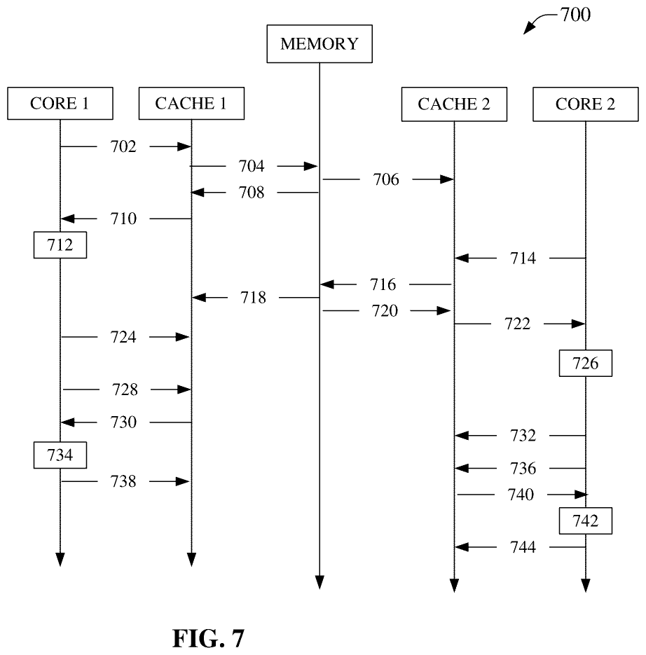

FIG. 7 illustrates an additional time-sequence diagram or flow diagram 700 for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various example embodiments. This illustration depicts how the described subject matter overcomes the situation depicted in the time sequence of FIG. 6 where there can be a bottleneck/pinch point, at act 620, where the data requested by the second thread is available in the first cache memory but is unavailable to service the second read request because the first thread, via the first processor, has a lock placed on the data contained in the first memory cache, hence the lock wait indication at 620.

In computing environments where processor performance can be measured in multiples of teraflops (e.g., trillions floating-point operations per second), a thread being placed in a wait locked state can be an interminable delay, which can have deleterious knock on consequences with regard to other threads that may, for example, be dependent on results supplied by the second thread. Further, there can be instances where a first thread can be dependent on results from a second thread and the second thread can be dependent on results from the first thread. In these circumstances, the use of per-CPU operations (e.g., tasks or operations that are performed independently by each CPU (central processing unit) in a multi-CPU or multi-core systems) can be beneficial in obviating lock wait indications.

At act 702, a first thread executing on a first processor of a first multi-core entity can initiate a first read request for data and direct the first read request to a first cache. At act 704, in response to determining that the requested data needed to fulfill the first read request is not available in the first cache, the first read request can be forwarded to a shared resource (e.g., data storage equipment, . . . ). In response to receiving the first read request a first snoop operation can be performed at act 706, wherein a determination can be made as to whether a second cache memory has previously retrieved and stored the data that has been requested in the first read request. Where the first snoop operation fails to locate the data that has been requested in the first read request at 706, the first read request can be satisfied by the shared resource. Whereupon the data to satisfy the first read request can be directed to the first cache memory at act 708, after which, at act 710, the first thread can access the data that is now resident in the first cache. Once the first thread has access to the data that it had requested by instantiating the first read request, the first processor, at act 712, can update a first counter for which the first processor is responsible.

At this point in time, like the situation described earlier in regard to flow chart 600, a second thread in operation of a second processor of a second core entity can make a request for the data (e.g., substantially similar data that was requested by the first thread execution on the first processor at act 702). Therefore, at act 714, the second thread in execution on the second processor, via an issued second read request, can cause the second processor to access a second cache memory to determine whether the second cache has the data requested in the second read request. Should the data requested by the second read request not be resident in the second cache memory, the second read request can be directed to the shared resource at act 716.

At this point in the time flow sequence 700 a second snoop operation can be performed, wherein the second snoop operation determines whether the first cache memory can fulfill the second read request at act 718. Here since the data resident in the first cache memory is being used by the first thread as indicated by the first counter value associated with the first counter maintained, for example, by the first processor in the first cache memory, the first processor can ensure that the first cache memory is not accessible. In response to the second snoop operation and an indication that the first cache memory is currently inaccessible and is therefore unable to satisfy the second read request, the data requested in the second read request can be fulfilled by the shared resource at act 720, whereupon the data to satisfy the second read request can be moved to the second cache memory so that, at act 722, the second thread in execution on the second processor can access the data that is now located in the second cache memory. Once the data requested by the second read request has been made accessible to the second thread executing on the second processor, the second processor can update a second counter maintained, for instance, in the second cache memory, with a second counter value at act 726.

Now at some point in time between the time that the first processor updates the first counter with a first counter value at act 712 and the time at which the second processor updates the second counter with the second counter value at act 726, the first thread operating on the first processor can effectuate a write operation to the data persisted in the first cache memory at act 724, and thereafter, at act 728, the first thread can make another read request for the data. Since the data that the first thread needs in making the additional read request is still being stored in the first cache memory, fulfillment of another read request can be performed at act 730.

More or less contemporaneously with the first thread requesting further access to the data stored in the first memory cache at act 720, the second thread in execution on the second processor can effectuate a write operation at act 732, wherein this write operation affects the data that is stored in the second cache memory. Thereafter, in close time proximity to act 732, the first processor in control of the first thread can update the first counter value as maintained by the first counter (e.g., since the first counter value was initially updated at act 712, this further update of the first counter with another first counter value, at act 734, would be an additional update to the first counter value monitored and maintained by the first processor). Shortly before or shortly after, at act 736, the second thread in operation on the second processor can request the second processor to perform an additional read request for the data. The second processor, observing that the second counter value that it monitors and maintains has already been updated once (e.g., at act 726), will retrieve the requested data from the second cache memory at act 740, and then, at act 742, facilitate an update of the second counter value associated with the second counter that is being maintained by the second processor. At about the same time while the second processor is retrieving the data requested by the second thread in the second read request, the first processor can update the first counter with an updated first counter value at act 734. The first counter value and the second counter value respectively maintained by the first processor and the second processor provide respective indication of how many times read requests have been initiated. For example, after the updating, at act 734, the first processor will be aware that there have been at least two data read requests initiated by the first thread operational on the first processor; similarly, at the completion of act 742, the second processor, based at least in part on querying the second counter (and associated second counter value) will be cognizant that the second thread in execution on the second processor has initiated requests for data at least twice.

At some time, subsequent to updating the first counter value at act 734, the first thread operating on the first processor can issue a write directive, at act 738, which can cause the first processor to perform a write operation on the data stored in the first cache memory. Similarly, at some point in time after the second processor has updated the second counter value at act 742, the second thread operational on the second processor can cause the second processor to initiate a write operation to be performed on the second cache memory at act 744.

As will be noted in reference to FIG. 7, in contrast to the situation described in relation to FIG. 6, there is no pinch point contention between the first thread operating on the first processor and the second thread operating on the second processor, as the second thread in operation on the second processor is not waiting for the first thread in operation on the first processor to relinquish locked data. It will also be observed that the use of locking directives has effectively been obviated, through the use of counters maintained and controlled by respective processors of the multi-CPU core, the use of synchronization directives which can be extremely inefficient and can be a source of significant time delays.

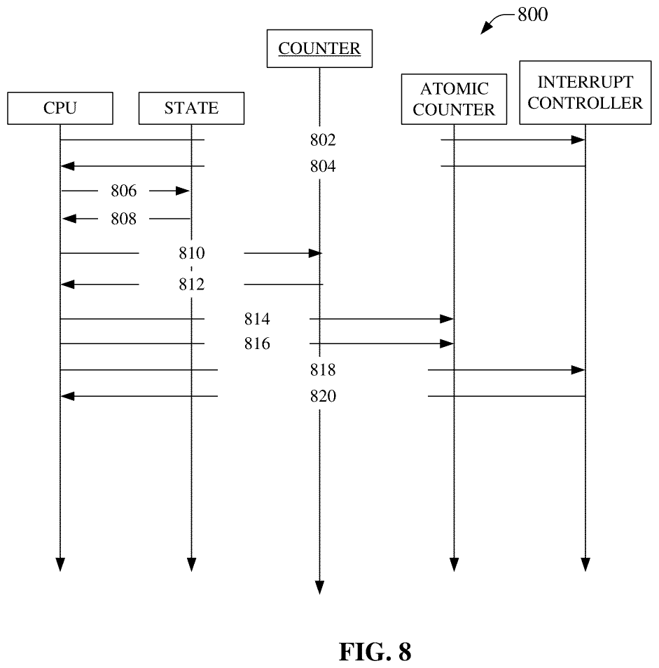

Now in reference to FIG. 8 and time sequence chart 800. Time sequence/state chart 800, in accordance with various embodiments, presents aspects of the disclosed increment operation. The time sequence/state chart 800 outlines the acts, states, counter (e.g., per-CPU counter), atomic counter, and interrupt controller from the perspective of a single processor (CPU) of a single multi-processor core. Moreover, time sequence/state chart 800 details the acts associated with the increment operation, pseudo code for which has been mentioned earlier. The single processor, in various embodiments, can be performing operations on behalf of a single thread of a group of single threads that can be executing on the single processor. In response to the single processor receiving, from the single thread in execution an instruction to initiate a read request for data, the single processor, at act 802, can send a command to an interrupt controller affiliated with the single processor to disable interrupts. The affiliated interrupt controller, in response to satisfying the command to disable interrupt, at act 804, can return a message to the single processor—to which it is tied—a notification that interrupts have been disabled. At act 806 the single process can cause a state value to be set to a read state, whereupon when the state value has been switched to the read state the state will have been set to the current state at act 808. Once act 802 to act 808 have been successfully carried out, at act 810, while in a PERCPU state, the single processor can cause a per-CPU counter (e.g., depicted as counter) to be incremented, whereupon once the per-CPU counter has been incremented, at act 812, a confirmation message can be directed to the single processor indicating that the per-CPU counter has been incremented. Alternatively, while in an ATOMIC state, at act 814, the single processor can also update an atomic counter that can indicate that a resource is currently being utilized. It should be noted at this juncture that the atomic counter, in some embodiments, can be implemented as a bit value supplement to the per-CPU counter value. The atomic counter is generally only used when access is being made of the shared resource by the single thread in operation on the single processor. For instance, when, and for as long as, the per-CPU counter value is not zero (e.g., indicating that the single thread in execution on the single processor has placed at least one read request for data) the atomic counter value can be one (1) (e.g., the increment operation is to operate as being in the PERCPU state). When the per-CPU counter value becomes zero, the atomic counter value can also be set to zero—an indication, to the single processor, that the single thread in execution on the single processor no longer has outstanding or unfulfilled read requests for use of the earlier requested/retrieved data, and as such when the per-CPU counter value is zero, the atomic counter value can be set to zero (e.g., the increment operation should now behave in accordance with being in the ATOMIC state). It should also be observed that while the per-CPU counter value is not zero and the atomic counter value is not zero (i.e., the increment operation is performing in the PERCPU state), the single thread in operation on the single processor can be perceived as being in a PERCPU state. Thus, at act 816, once the single processor has determined that the single thread in execution on the single processor no longer has further need for the retrieved data, the single processor can provide indication, based at least on the per-CPU counter being zero, that the atomic counter should be also be set to zero (e.g., switching the states from PERCPU to ATOMIC). Thus, concomitantly, when both the per-CPU counter value being zero and the atomic counter value being zero, the state can change from being in a PERCPU state to being in an ATOMIC state. It should be observed that acts 810 and 812 are performed while in the PERCPU state, whereas acts 814 and 816 are carried out while in the ATOMIC state. The PERCPU state and the ATOMIC state are alternate complimentary states, and as such, actions 810 and 812 are generally only carried out while in the PERCPU state, and actions 814 and 816 are typically only carried out while being in the ATOMIC state.

It should be noted that while in the PERCPU state acts 810 and 812 can be repeatedly performed, wherein the single thread operating on the single processor can issue multiple read requests for access to the data, that can have initially been retrieved from shared storage equipment to cache memory in response to an initial read request from the single thread, but whereupon, until there is a transition to the ATOMIC state, the per-CPU counter can be incremented. It is only when the process attains the ATOMIC state that acts 814 and 816 are performed. It should also be noted that the ATOMIC state can be an extremely short lived state; it is when the process in the ATOMIC state that the data can be made widely available to other threads of the plurality of threads operational on the single multi-processor core, as well as threads that can be in execution on distinct other multi-processor cores.

Once an ATOMIC state has been achieved, the single processor can message the interrupt controller to enable interrupts at act 818, whereupon and in response to the interrupt controller enabling interrupts, the interrupt controller can send the single processor notification that the operation of enabling interrupts has been successful.

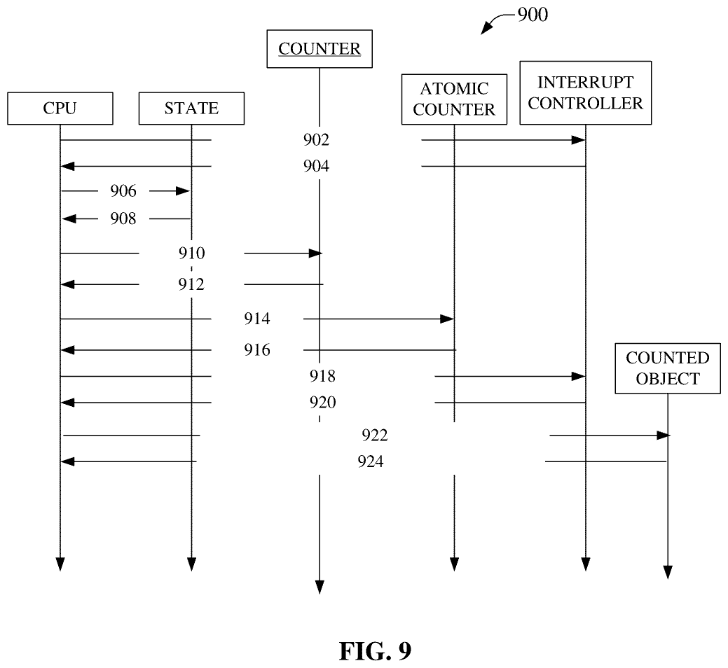

With regard to FIG. 9, flow chart/state diagram 900 outlines the acts, states, etc. associated with the decrement operation, pseudo code for which has been outlined above. Once again the decrement operation is described from the perspective of a single processor of a single multi-CPU processor core, wherein the single processor is executing a thread of a plurality of threads. It should be noted that the described decrement operation can be the counter part of the increment operation described above, and as such can collaborate with the increment operation described. Flow chart/state diagram 900 can begin at act 902, where the single processor (CPU) issues a directive to an interrupt controller to disable interrupts. At act 904, the interrupt controller can response with a message notifying the single processor that interrupts have been disabled. At act 906, the single process can cause a state value to be set to a read state, whereupon the state value is switched to the read state, and the current state value will now be the read state at act 908. In response to the state being set to the read state the single processor can operate in the PERCPU state (e.g. the per-CPU counter value is not zero), as such in the PERCPU state and in accordance with the decrement operation the single processor can decrement the per-CPU counter at act 910 (see FIG. 8 for the increment operation) and receive confirmation that the per-CPU counter has been decremented at act 912. The acts 910 and 912 can be performed until the per-CPU counter falls to zero, at which point the finalize process, detailed above, can effectuate a state switch from the per-CPU state to the ATOMIC state can be effectuated by decrementing the atomic counter so that a bit flag representative of the atomic counter, for example, can be switched from one (1) to zero (0). At this point in time, at act 918, interrupts can be enabled and a confirmatory message at act 920 can be sent back to the single processor. In regard to act 920 and act 922, these acts in some embodiments can be optionally performed whilst in the ATOMIC state. In accord with act 922, the single processor can reclaim a reference counted object (counted object), whereupon once the reference counted object has been reclaimed a message can be directed to the single processor indicating that the reference counted object has been successfully reclaimed.

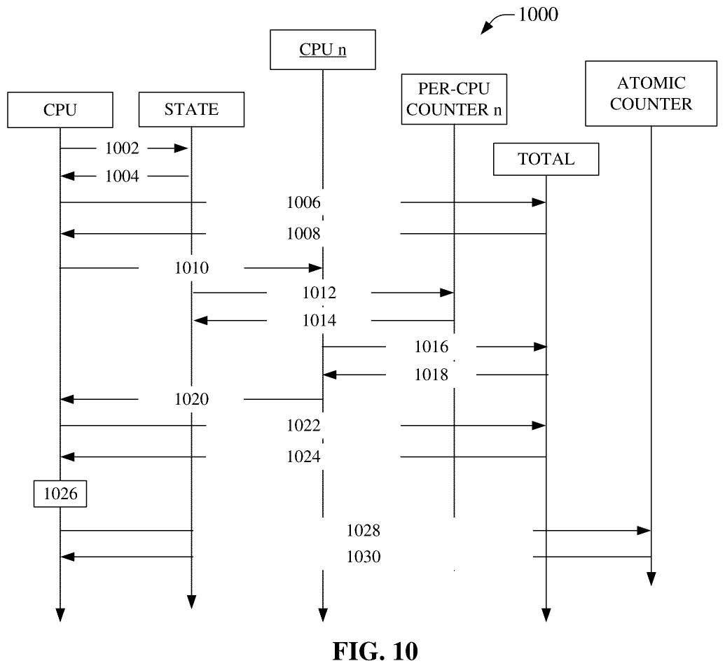

In reference now to FIG. 10 that presents flow chart/state diagram 1000 that outlines the acts, states, etc. associated with the finalize operation, pseudo code for which has been noted above. As with the increment operation and the decrement operation, the finalize operation is described from the perspective of a single thread executing on a single processor of a single multi-processor core equipment. At act 1002, a single processor can make a determination as to whether there has been a change of state from a PERCPU state to an ATOMIC state. In instances where there has been a change from a PERCPU state to an ATOMIC state and based on the state having changed from the PERCPU state to the ATOMIC state, at act 1004, the single processor can set a counter value (total) to zero and, at act 1006, receive confirmation that the total counter value has been set to zero. At act 1010, an interrupt can be initiated on a processor n (where n is a whole number value and processor n is a processor of a plurality of processors comprising a multi-processor core) to add a per-CPU counter value to the total counter value. At act 1012, a read can be effectuated to read the per-CPU counter associated with processor n, and, at act 1014, the current counter value of can be returned. Further, at act 1016, the counter representing the total counter value can be atomically incremented and confirmation of the total counter value can be returned back to processor n at act 1018, and then the interrupt that was initiated at act 1010 can be considered completed at act 1020. The acts 1010 to 1020 can be performed in a loop for each processor n comprising the plurality of processor comprising the multi-processor core. At act 1022, after dropping out of the loop, the value associated with the total value counter can be noted and returned to the single processor at act 1024, at which point the total value can be adjusted to subtract most significant bit bias (e.g., errors or biases introduced in digital systems due to the way numbers are represented and processed, particularly in binary form) at act 1026. At act 1028, the total counter value can be atomically added to the atomic counter value, at which point, at act 1030, the atomic counter update is complete.

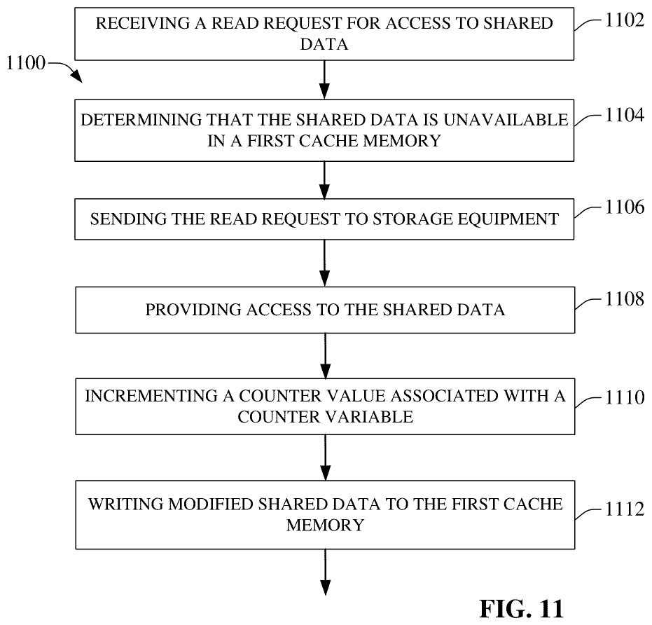

FIG. 11 illustrates a method 1100 for per-CPU reference counting leveraging per-CPU operations, such as interrupt handing, pre-emption, inter-process interrupts, and the like to avoid the use of more complicated synchronization primitives used in concurrent programming in order to coordinate the execution of multiple threads or processes and manage shared resources in complex scenarios, in accordance with various example embodiments. Method 1100 can begin at act 1102, where a read request for access to shared data from a thread of a group of threads in execution on the at least one processor can be received. At act 1104, based on the read request, a determination regarding whether the shared data is unavailable in a first cache memory can be made. At act 1106, in response to determining that the shared data is unavailable, the read request can be directed to storage server equipment, wherein the storage server equipment, in response to receiving the read request searches a second cache memory to determine whether or not the shared data is unavailable in the second cache memory. Based on the shared data being unavailable in both the first cache memory and the second cache memory, the storage server equipment can send the shared data to the first cache memory. At act 1108, access to the shared data can be provided to the thread of the group of threads. At act 1110, a counter value stored in a counter variable and controlled by the processor can be incremented, and, at act 1112, based on the thread having modified the shared data, the modified shared data can be stored to the first cache memory for future access, by the thread.

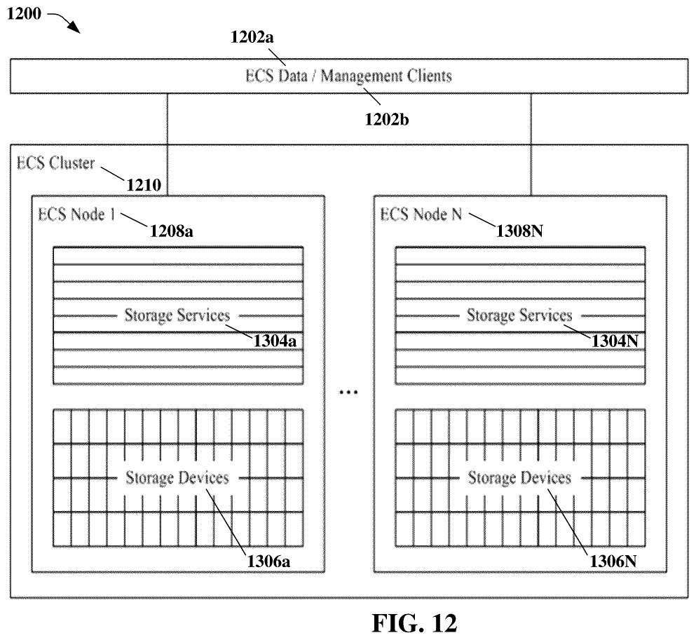

In the following, FIG. 12 describes an example non-limiting cloud storage system in the non-limiting context of an ECS storage system, but for the avoidance of doubt, the subject embodiments can apply to any storage platform. For instance, in this regard, FIG. 12 illustrates an ECS storage system 1200 comprising a cloud-based object storage appliance in which corresponding storage control software comprising, e.g., ECS data client(s) 1202a, ECS management client(s) 1202b, storage service(s) 1204a . . . 1204N, etc. and storage devices 1206a . . . 1206N (e.g., storage media, such as physical magnetic disk media, etc. of respective ECS nodes of ECS cluster 1210) are combined as an integrated system with no access to the storage media other than through the ECS storage system 1200.

In this regard, ECS cluster 1210 comprises multiple nodes 1208a . . . 1208N, storage nodes, ECS nodes, etc. Each node is associated with storage devices 1206a . . . 1206N, e.g., hard drives, physical disk drives, storage media, etc. In embodiment(s), ECS node 1208a, or any ECS node, executing on a hardware appliance can be communicatively coupled, connected, cabled to, etc., e.g., 15 to 120 storage devices. Further, each ECS node can execute one or more services for performing data storage operations described herein.

For instance, the ECS storage system 1200 can be an append-only virtual storage platform that protects content from being erased or overwritten for a specified retention period. In particular, the ECS storage system 1200 does not employ traditional data protection schemes like mirroring or parity protection. Instead, the ECS storage system 1200 utilizes erasure coding for data protection, wherein data, a portion of the data, e.g., a data chunk, is broken into fragments, and expanded and encoded with redundant data pieces and then stored across a set of different locations or storage media, e.g., across different storage nodes.

The ECS storage system 1200 can support storage, manipulation, and/or analysis of unstructured data on a massive scale on commodity hardware. As an example, the ECS storage system 1200 can support mobile, cloud, big data, and/or social networking applications. In another example, the ECS storage system 1200 can be deployed as a turnkey storage appliance, or as a software product that can be installed on a set of qualified commodity servers and disks, e.g., within a node, data storage node, etc. of a cluster, data storage cluster, etc. In this regard, the ECS storage system 1200 can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

In embodiment(s), the cloud-based data storage system can comprise an object storage system, e.g., a file system comprising, but not limited to comprising, a Dell EMC® Isilon file storage system. As an example, a storage engine can write all object-related data, e.g., user data, metadata, object location data, etc. to logical containers of contiguous disk space, e.g., such containers comprising a group of blocks of fixed size (e.g., 128 MB) known as chunks. Data is stored in the chunks and the chunks can be shared, e.g., one chunk can comprise data fragments of different user objects. Chunk content is modified in append-only mode, e.g., such content being protected from being erased or overwritten for a specified retention period. When a chunk becomes full enough, it is sealed, closed, etc. In this regard, content of a sealed, closed, etc. chunk is immutable, e.g., read-only, and after the chunk is closed, the storage engine performs erasure-coding on the chunk.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component,” “system,” “engine”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to determine probabilistic likelihoods that code paths utilize operating system synchronization mechanism, as described herein.

A classifier can be a function that maps an input attribute vector, x=(x1, x2, x3, x4, . . . , xn), to a confidence that the input belongs to a class, that is, f (x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a server, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by variance engine 102.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” “socket”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a data storage cluster, non-volatile memory 1322, disk storage 1324, and/or memory storage 1346, further description of which is below. For instance, nonvolatile memory can be included in read only memory (ROM), programmable ROM (PROM), electrically programmable ROM (EPROM), electrically erasable ROM (EEPROM), or flash memory. Volatile memory 1320 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

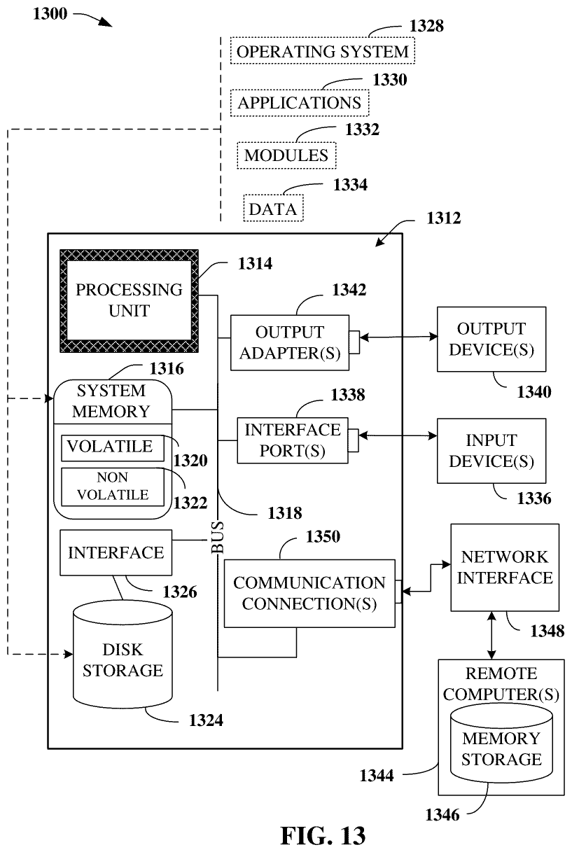

In order to provide a context for the various aspects of the disclosed subject matter, FIG. 13, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 13, a block diagram of a computing system 1300, e.g., system 130, operable to execute the disclosed systems and methods is illustrated, in accordance with an embodiment. Computer 1312 comprises a processing unit 1314, a system memory 1316, and a system bus 1318. System bus 1318 couples system components comprising, but not limited to, system memory 1316 to processing unit 1314. Processing unit 1314 can be any of various available processors. Dual microprocessors and other multiprocessor architectures also can be employed as processing unit 1314.

System bus 1318 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1316 comprises volatile memory 1320 and nonvolatile memory 1322. A basic input/output system (BIOS), containing routines to transfer information between elements within computer 1312, such as during start-up, can be stored in nonvolatile memory 1322. By way of illustration, and not limitation, nonvolatile memory 1322 can comprise ROM, PROM, EPROM, EEPROM, or flash memory. Volatile memory 1320 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also comprises removable/non-removable, volatile/non-volatile computer storage media. FIG. 13 illustrates, for example, disk storage 1324. Disk storage 1324 comprises, but is not limited to, devices like a magnetic disk drive, floppy disk drive, tape drive, Jaz drive, Zip drive, LS-100 drive, flash memory card, or memory stick. In addition, disk storage 1324 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to system bus 1318, a removable or non-removable interface is typically used, such as interface 1326.

It is to be appreciated that FIG. 13 describes software that acts as an intermediary between users and computer resources described in suitable operating environment 1300. Such software comprises an operating system 1328. Operating system 1328, which can be stored on disk storage 1324, acts to control and allocate resources of computer system 1312. System applications 1330 take advantage of the management of resources by operating system 1328 through program modules 1332 and program data 1334 stored either in system memory 1316 or on disk storage 1324. It is to be appreciated that the disclosed subject matter can be implemented with various operating systems or combinations of operating systems.

A user can enter commands or information into computer 1312 through input device(s) 1336. Input devices 1336 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1314 through system bus 1318 via interface port(s) 1338. Interface port(s) 1338 comprise, for example, a serial port, a parallel port, a game port, a universal serial bus (USB), a wireless based port, e.g., Wi-Fi, Bluetooth, etc. Output device(s) 1340 use some of the same type of ports as input device(s) 1336.

Thus, for example, a USB port can be used to provide input to computer 1312 and to output information from computer 1312 to an output device 1340. Output adapter 1342 is provided to illustrate that there are some output devices 1340, like display devices, light projection devices, monitors, speakers, and printers, among other output devices 1340, which use special adapters. Output adapters 1342 comprise, by way of illustration and not limitation, video and sound devices, cards, etc. that provide means of connection between output device 1340 and system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. Remote computer(s) 1344 can be a personal computer, a server, a router, a network PC, a workstation, a microprocessor based appliance, a peer device, or other common network node and the like, and typically comprises many or all of the elements described relative to computer 1312.

For purposes of brevity, only a memory storage device 1346 is illustrated with remote computer(s) 1344. Remote computer(s) 1344 is logically connected to computer 1312 through a network interface 1348 and then physically and/or wirelessly connected via communication connection 1350. Network interface 1348 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1350 refer(s) to hardware/software employed to connect network interface 1348 to bus 1318. While communication connection 1350 is shown for illustrative clarity inside computer 1312, it can also be external to computer 1312. The hardware/software for connection to network interface 1348 can comprise, for example, internal and external technologies such as modems, comprising regular telephone grade modems, cable modems and DSL modems, wireless modems, ISDN adapters, and Ethernet cards.

The computer 1312 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1312 can connect to other devices/networks by way of antenna, port, network interface adaptor, wireless access point, modem, and/or the like.

The computer 1312 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

1. A system, comprising:
at least one processor; and
at least one memory that stores executable instructions that, when executed by the at least one processor, facilitate performance of operations, comprising:
receiving, from a thread of a group of threads, a read request for access to requested data;
determining, based on the read request, that the requested data is unavailable in a first cache memory;
based on the requested data being determined to be unavailable in the first cache memory, sending the read request for access to the requested data to storage server equipment for fulfillment of the read request;
performing, by the storage server equipment, a snoop operation on a second cache memory, and transferring the requested data, from the storage server equipment, to the first cache memory;
providing access, by the thread of the group of threads, to the requested data stored in the first cache memory;
incrementing, by a processor of the at least one processor, a counter value stored in a counter variable exclusively maintained by the processor of the at least one processor, wherein the thread of the group of threads is executed solely on the processor, and wherein, prior to the incrementing, placing an inter-processor interrupt process, operating on the processor, into a hiatus state; and
in response to the thread of the group of threads having modified the requested data to create modified requested data, writing the modified requested data to the first cache memory for future access to the modified requested data by the thread of the group of threads, and transitioning the inter-processor interrupt process from the hiatus state to an operational state.

2. The system of claim 1, wherein the thread of the group of threads is a first thread of a first group of threads, the read request is a first read request, the processor of the at least one processor is a first processor of a first group of the at least one processor, the snoop operation is a first snoop operation, the counter value is a first counter value, the counter variable is a first counter variable, the modified requested data is first modified requested data, and the first thread of the first group of threads is in execution on the first processor of the first group of the at least one processor, and wherein the operations further comprise:
at a time in near contemporaneity with the receiving, from the first thread, the first read request for access to the requested data, receiving, from a second thread of a second group of threads in execution on a second processor of a second group of the at least one processor, a second read request for access to the requested data;
determining, based on the second read request, that the requested data is unavailable in the second cache memory;
based on the requested data being unavailable in the second cache memory, sending the second read request for access to the requested data to the storage server equipment for fulfillment of the second read request;
causing the storage server equipment to perform a second snoop operation on the first cache memory, and transfer the requested data, from the storage server equipment, to the second cache memory;
providing access, by the second thread of the second group of threads, to the requested data stored in the second cache memory; and
in response to the second thread of the second group of threads having modified the requested data to create second modified requested data, writing the second modified requested data to the second cache memory for future access to the second modified requested data by the second thread of the second group of threads.

3. The system of claim 2, wherein the operations further comprise incrementing, by the second processor, a second counter value stored in a second counter variable exclusively maintained by the second processor.

4. The system of claim 3, wherein the first counter variable is persisted to the first cache memory and the second counter variable is persisted to the second cache memory.

5. The system of claim 2, wherein the first cache memory only services the first processor, and the second cache memory services only the second processor.

6. The system of claim 2, wherein the requested data represents a resource that is shared between the first group of the at least one processors and the second group of the at least one processors.

7. The system of claim 2, wherein the operations further comprise, in response to determining that the first counter value of the first counter variable that has been stored in the first cache memory is greater than zero, operating the first processor in a per-CPU state.

8. The system of claim 7, wherein subsequent first read requests are serviced by the first cache memory, and wherein, in response to each of the subsequent read requests, a scheduler process operational on the first processor is halted, the inter-processor interrupt process operational on the first processor is halted, and the first counter value of the first counter variable is incremented.

9. The system of claim 2, wherein the operations further comprise, in response to determining that the first counter value of the first counter variable that has been stored in the first cache memory is zero, executing the first processor to operate in an atomic state.

10. The system of claim 2, wherein the operations further comprise, in response to determining that the first counter value of the first counter variable that has been stored in the first cache memory is zero, placing in hiatus a scheduler process operational on the first processor, placing in hiatus the inter-processor interrupt process operational on the first processor, and initiating a resource reclamation process that clears the first cache memory.

11. A method, comprising:
receiving, by a processor of a multi-processor core, a read request for access to shared data from a thread of a group of threads in execution exclusively on the processor;
based on the read request, determining, by the processor, that the shared data is unavailable in a first cache memory, wherein the first cache memory is used for modification and storage of the shared data only by the processor;
facilitating, by the processor, transmitting the read request to storage server equipment, wherein the storage server equipment, in response to receiving the read request, is to poll a second cache memory to determine that the shared data is unavailable in the second cache memory, and based on the shared data being determined to be unavailable in the second cache memory, the storage server equipment is to send the shared data to the first cache memory;
enabling, by the processor, access to the shared data to the thread of the group of threads;
incrementing, by the processor, a counter value stored in a counter variable exclusively controlled by the processor, wherein, prior to the incrementing, placing an inter-processor interrupt process specifically associated with the processor into a temporary halt state; and
based on the thread having modified the shared data to generate modified shared data, writing, by the processor, the modified shared data to the first cache memory for future access to the modified shared data by the thread, and bringing the inter-processor interrupt process specifically associated with the processor back to an operational state.

12. The method of claim 11, wherein the counter variable is stored in the first cache memory and wherein the incrementing of the counter value stored in the counter variable results in generation of an incremented counter value.

13. The method of claim 11, wherein the thread of the group of threads is a first thread of a first group of threads, the processor is a first processor of the multi-processor core, and the read request for access to the shared data is a first read request for access to the shared data, and wherein a second thread of a second group of threads in execution on a second processor of the multi-processor core receives a second read request for access to the shared data.

14. The method of claim 11, wherein the thread of the group of threads is a first thread of a first group of threads, the processor is a first processor of the multi-processor core, and the read request for access to the shared data is a first read request for access to the shared data, the first processor controls access, by the first thread, to the first cache memory, and a second processor of the multi-processor core controls access, by a second thread of a second group of threads in execution on the second processor, to the second cache memory.

15. The method of claim 11, wherein the processor is a first processor of the multi-processor core, and wherein the shared data represents a resource that is shared by the first processor and a second processor of the multi-processor core.

16. The method of claim 11, further comprising:
in response to determining that the counter value associated with the counter variable that has been stored in the first cache memory is zero, initiating a resource reclamation process that transfers the modified shared data stored in the first cache memory to the storage server equipment.

17. The method of claim 16, wherein the read request is a first read request, and wherein the incrementing of the counter value comprises incrementing the counter value in response to the thread initiating a second read request for access to the modified shared data.

18. The method of claim 11, further comprising:
prior to the incrementing of the counter value stored in the counter variable, halting, by the processor, a scheduler process, and, in response to determining the incrementing of the counter value has completed, restarting the scheduler process.

19. A non-transitory machine-readable medium comprising instructions that, in response to execution, cause a system comprising at least one processor of a multi-processor core to perform operations, comprising:
receiving a read request for access to shared data from a thread of a group of threads in execution on the at least one processor;
based on the read request, determining that the shared data is unavailable in a first cache memory;
in response to determining that the shared data is unavailable, transmitting the read request to storage server equipment, wherein the storage server equipment, in response to receiving the read request is to search a second cache memory to determine that the shared data is unavailable in the second cache memory, and based on the shared data being unavailable in both the first cache memory and the second cache memory, the storage server equipment sends the shared data to the first cache memory;
providing access to the shared data to the thread of the group of threads;
incrementing a counter value stored in a counter variable controlled by the at least one processor, wherein, prior to the incrementing, an inter-processor interrupt process, executing on the at least one processor, is transitioned to a halt state; and
based on the thread having modified the shared data resulting in modified shared data, storing the modified shared data to the first cache memory for future access, by the thread, to the modified shared data, and re-establishing execution of the inter-processor interrupt process on the at least one processor.

20. The non-transitory machine-readable storage medium of claim 19, wherein the operations further comprise, prior to performing the incrementing of the counter value stored in the counter variable, halting a scheduler process associated with the processor, and, in response to determining that the incrementing of the counter value has completed, restarting the scheduler process.
